(19) United States
(12) Patent Application Publication
(10) Pub. No.: US 2004/0099147 A1
(43) Pub. Date: May 27, 2004

(54) Composite structure, method for making a composite structure and heating device with composite structure

(75) Inventors: Stefan Hubert, Engelstadt (DE); Ted Wegert, Louisville, KY (US); Karen Thompson, Louisville, KY (US)

Correspondence Address: Walter Ottesen, Patent Attorney, P.O. Box 4026, Gaithersburg, MD, 20885-4026, US

(73) Assignee: Schott Glas

(21) Appl. No.: 10/301,648

(22) Filed: Nov. 22, 2002

(51) Int. Cl. A47J 37/10

(52) U.S. Cl. 99/422

(57) ABSTRACT

A composite structure (1) includes a solid carrier (2), which is at least partially covered by a first adhesive layer (3). This first adhesive layer (3) is strengthened by strengthening material (4) arranged on said first adhesive layer (3). The invention further relates to a method of making such a composite structure. This composite structure may be in the form of a bowl-shaped structure to receive a bowl-shaped cooking pan in a heating device.

### FIELD OF THE INVENTION

The invention relates to an impact resistant composite structure which may be used in a heating device for receiving a bowl-shaped cooking pan and a method of manufacturing such a composite structure. The invention further relates to a heating device which includes such a composite structure.

### BACKGROUND OF THE INVENTION

U.S. Pat. No. 5,687,642 discloses a heating device having a concave induction cooking surface for wok cooking in a round bottomed wok made of ferrous material which is placed on top of this cooking surface. The cooking surface consists of a concave glass surface with a concave induction coil located underneath. The concave glass surface and the concave induction coil are mounted on a cooking unit having a control knob and a visual display. Similar cooking surfaces are disclosed in European patent publication 0 629 820 A2 and German patent publication 298 20 731 U1. Such cooking surfaces can be easily damaged if they are subject to impact or shock. This is because a concave surface structure does not allow for dissipation of shock and impact energy through vibrations. The only way energy can be absorbed in such a structure is by cracking or breaking. There is a serious risk that through such cracks and breaks water or other liquids used for cooking or cleaning can penetrate to the interior of the heating device. As in the interior of these devices various electrical parts are accommodated, this may cause short circuits and cause damage to electrical units.

### SUMMARY OF THE INVENTION

It is an object of the invention to provide an impact-resistant cooking surface, which, in case of cracking upon impact, does not allow penetration of fluid to the interior of the device.

This object is achieved by providing a composite structure having a solid carrier which is at least partially covered by a first adhesive layer. This first adhesive layer is strengthened by strengthening or reinforcing material arranged on this layer. In case of breaking of the solid carrier within the composite structure, the adhesive layer strengthened by the strengthening material impedes the penetration of fluids through the composite structure.

Preferably, the solid carrier is made of glass, ceramic or glass-ceramic, while the first adhesive layer consists of temperature resistant elastic adhesive, such as room-temperature-vulcanizing (RTV) silicone. As a strengthening material, a temperature-resistant elastic material or fiberglass material in form of a netting, a mesh or a mat may be used. In principle, the strengthening material could also be metallic. However, in order to exclude electrical hazard when used in connection with electrical devices, a strengthening material which is insulating should be used. In another preferred embodiment the strengthening material is covered by a second adhesive layer of temperature-resistant silicone adhesive or sealant which can, for example, also be RTV silicone. The structure can have a concave surface shape forming a bowl. Such bowl-shaped composite structure may be used in a heating device for receiving bowl-shaped cooking pans as, for example, woks. In this case, the solid carrier inner concave surface faces to the bowl while the convex surface faces to the interior of the heating device and the interior of the heating device is protectively sealed by the adhesive layer combined with the strengthening material.

The composite structure can be manufactured by applying a first silicone adhesive layer to a glass or ceramic or a glass-ceramic solid carrier in a first step. In a second step, a plastic or metallic netting, mesh or net is placed as a strengthening material on this first silicone layer. Optionally, in a third step, a second silicone layer is applied.

### BRIEF DESCRIPTION OF THE DRAWINGS

The invention will now be described with reference to the drawings wherein:

FIG. 1 shows a composite structure for use in a heating device;

FIG. 2 shows a silicone-coated ceramic bowl which forms a composite structure;

FIG. 3 shows a heating device for bowl-shaped cooking pans including a silicone-coated ceramic bowl; and,

FIG. 4 illustrates the principle of induction heating of a metallic bowl-shaped cooking pan in such a heating device.

### DESCRIPTION OF THE PREFERRED EMBODIMENTS OF THE INVENTION

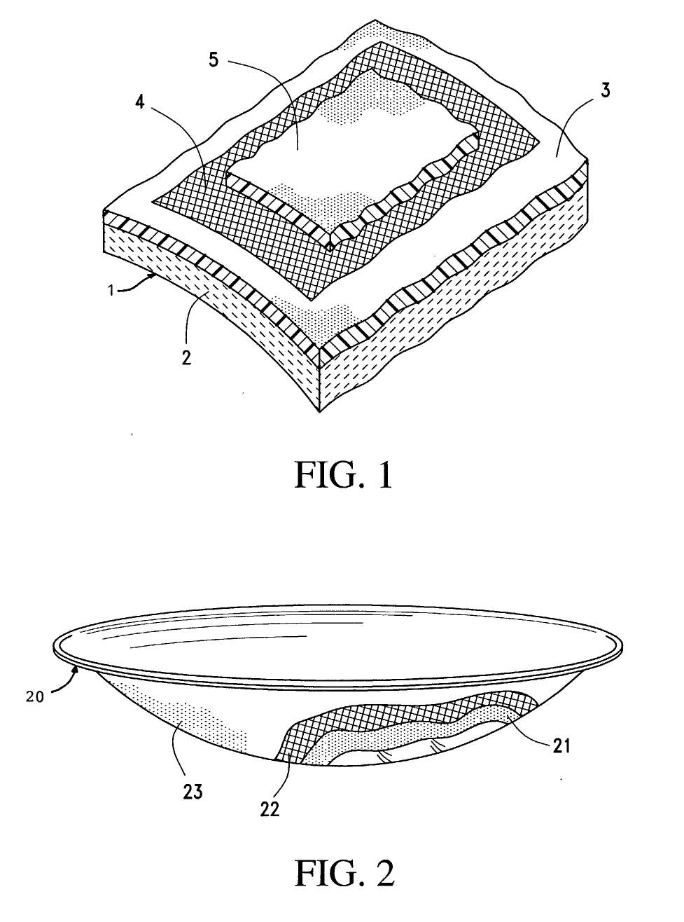

FIG. 1 is a schematic view of a composite structure 1 for use in a heating device. The composite structure 1 is based on a solid carrier material 2. This solid carrier material 2 consists of heat resistant ceramic. Alternatively, heat resistant glass or glass-ceramic could also be used as a carrier material. The carrier material 2 is coated with a first adhesive layer 3 of temperature-resistant silicone. On this first adhesive layer 3, a fiberglass netting 4 is placed. This fiberglass netting 4 is covered by a second adhesive layer 5 of the same temperature-resistant silicone. The fiberglass netting 4 is thus completely embedded in silicone, which covers the carrier material 2. The fiberglass netting 5 forms a strengthening material and strengthens the silicone. As an alternative for the fiberglass netting 4, a plastic netting or a metal netting or corresponding meshes or mats could be used. If metal netting is used, then care must be taken in the selection thereof so that the metal does not become hot because of inductive coupling.

FIG. 2 shows a silicone-coated ceramic bowl 20 forming a concave-shaped composite structure as described above. The ceramic bowl has a diameter of approximately 40 cm and a height of approximately 15 cm. The thickness of the ceramic material of the ceramic bowl is 2 mm approximately. The outer convex surface of the ceramic bowl is covered with a first adhesive layer 21 out of elastic adhesive or sealant of approximately 1 mm or greater thickness which is applied by various methods, such as spraying. Such elastic adhesive or sealant is a one component or multiple component silicone which can be applied and cured at room temperature or at elevated temperatures and is known to be heat resistant in the temperature range required for heating devices (for RTV adhesives, this temperature range lies below 350° C.). It is noted that this material is widely used as a gasket in similar applications. On this first silicone layer 21 there is strengthening material 22 in form of a fiberglass netting having a mesh size of approximately 0.25 inches. In principle also a smaller mesh size could be used. This strengthening material is covered with a second adhesive layer 23 of silicone adhesive or sealant which is again applied by spraying such that the strengthening material 22 is completely embedded in the silicone. Finally, the silicone on the heat resistant ceramic is allowed to cure at room temperature or at elevated temperatures.

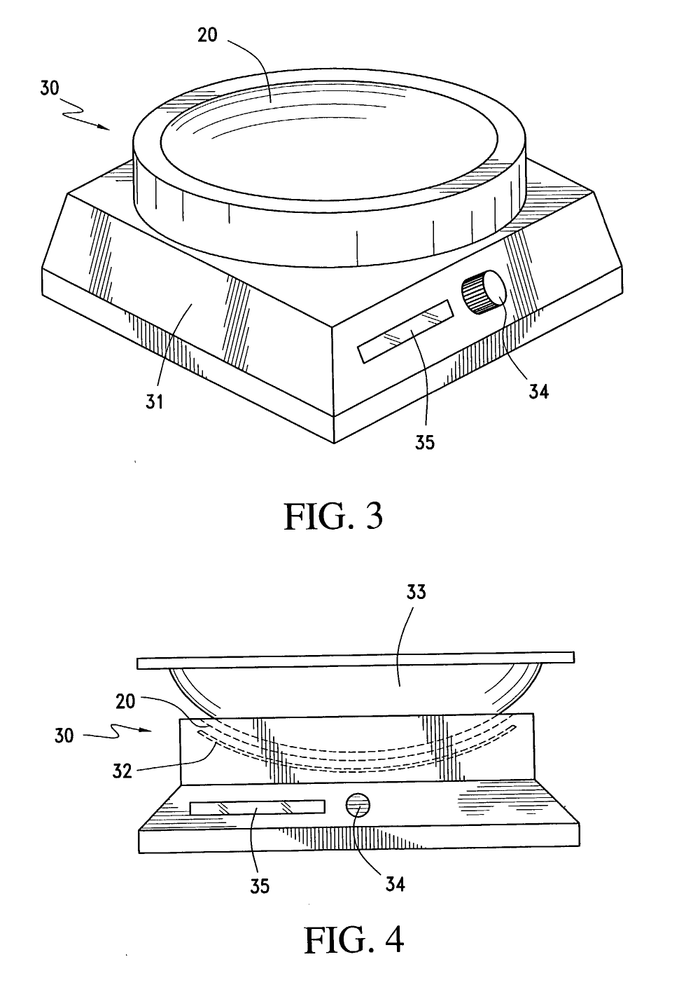

The silicone-coated ceramic bowl presented in FIG. 2 is part of a heating device for bowl-shaped cooking pans such as woks. The heating device is presented in FIG. 3 and FIG. 4 which is explained in the following.

The cooking device 30 includes a housing 31 in which the silicone-coated ceramic bowl 20 is received to form an induction cooking surface. As shown in FIG. 4, the cooking device 30 includes an induction coil unit 32 for heating a metallic wok-shaped pan 33. On the cooking device 30, a control knob 34 is provided for adjusting the amount of electric current flowing through the induction coil 32. The housing 31 further includes a display 35 for providing a user of the cooking device with visual feedback as to the amount of electrical current supplied to the induction coil 32.

Any shocks or impacts on the cooking device bear the risk of damage of the ceramic bowl 20 as the bowl-shaped structure of the ceramic does not allow for a dissipation of energy through vibrations and the ceramic easily breaks upon impact. This is where the strengthened silicone layer on the ceramic structure comes into play: even after a breaking of the ceramic, the silicone layer provides a tight seal for the ceramic bowl while the strengthening material 22 in the silicone layer provides for mechanical stability of the arrangement and absorbs axial forces exerted on the ceramic bowl as for example in an impact test according to US standard UL 197. It is noted that the parameters of the silicone coated ceramic bowl allow the heating device to meet the US standards UL 858 and UL 197. The silicone impedes penetration of dish water or other fluids to the interior of the housing 31 of the cooking device 30, where this could destroy electrical units or give rise to dangerous short circuits.

It is understood that the foregoing description is that of the preferred embodiments of the invention and that various changes and modifications may be made thereto without departing from the spirit and scope of the invention as defined in the appended claims.

What is claimed is:

1. A composite structure comprising:
a solid carrier material;
a first adhesive layer covering said solid carrier material at least partially; and,
strengthening material arranged on said first adhesive layer.

2. The composite structure of claim 1, wherein said solid carrier material consists of one of glass, ceramic, or glass-ceramic.

3. The composite structure of claim 1, further comprising a second adhesive layer which covers said strengthening material.

4. The composite structure of claim 3, wherein said first adhesive layer and said second adhesive layer consist of temperature-resistant silicone.

5. The composite structure of claim 1, wherein said strengthening material is a temperature-resistant plastic material.

6. The composite structure of claim 1, wherein said strengthening material is a temperature-resistant fiberglass material.

7. The composite structure of claim 1, wherein said strengthening material consists of one of a netting, a mesh, or a mat.

8. The composite structure of claim 1, wherein said structure has a concave surface.

9. A composite concave structure for accommodating a wok-type cooking pan therein, the composite structure comprising:
a bowl-shaped solid carrier having an outer convex surface and said solid carrier being made of glass, ceramic or glass-ceramic;
a first adhesive layer covering said solid carrier on said convex surface thereof;
a strengthening material disposed on said first adhesive layer; and,
a second adhesive layer covering said strengthening material so as to cause said strengthening material to be embedded between said first and second adhesive layers.

10. The composite structure of claim 9, wherein said first adhesive layer and said second adhesive layer consist of temperature-resistant silicone.

11. The composite structure of claim 9, wherein said strengthening material is a temperature-resistant plastic material.

12. The composite structure of claim 9, wherein said strengthening material is a temperature-resistant fiberglass material.

13. The composite structure of claim 9, wherein said strengthening material consists of one of a netting, a mesh, or a mat.

14. A method of making a composite structure comprising the steps of:
providing a solid carrier made of glass, glass-ceramic or ceramic;
applying a silicone layer to said solid carrier; and,
placing strengthening material on said silicone layer with said strengthening material being a netting, a mesh or a mat.

15. The method of claim 14, said silicone layer being a first silicone layer; and, said method further comprising the step of applying a second silicone layer to said strengthening material thereby embedding said strengthening material between said first and second silicone layers.

16. A heating device for bowl-shaped cooking utensils comprising:
a bowl-shaped composite structure for receiving a bowl-shaped cooking utensil;
the composite structure including a solid carrier;
an adhesive layer at least partially covering said solid carrier; and,
strengthening material arranged on said adhesive layer.

17. The heating device of claim 16, wherein said solid carrier material consists of one of glass, ceramic, or glass-ceramic.

18. The heating device of claim 16, wherein said adhesive layer is a first adhesive layer; and, said structure further including a second adhesive layer which covers said strengthening material.

19. The heating device of claim 18, wherein said first adhesive layer and said second adhesive layer consist of temperature-resistant elastic adhesive.

20. The heating device of claim 16, wherein said strengthening material is a temperature-resistant plastic material.

21. The heating device of claim 16, wherein said strengthening material is a temperature-resistant fiberglass material.

22. The heating device of claim 16, wherein said strengthening material consists of one of a netting, a mesh or a mat.
